(19) United States
(12) Patent Application Publication
(10) Pub. No.: US 2007/0203299 A1
(43) Pub. Date: Aug. 30, 2007

(54) High melt strength polypropylene

(75) Inventors: Harilaos Mavridis, Cincinnati, OH (US); Manivakkam J. Shankernarayananan, Cincinnati, OH (US)

Correspondence Address: DILWORTH & BARRESE, LLP, 333 EARLE OVINGTON BLVD., SUITE 702, UNIONDALE, NY, 11553, US

(73) Assignee: Novolen Technology Holdings C.V.

(21) Appl. No.: 11/363,018

(22) Filed: Feb. 27, 2006

(51) Int. Cl. C08L 23/04

(52) U.S. Cl. 525/240

(57) ABSTRACT

A method for producing a polypropylene-containing composition which includes (a) polymerizing a first quantity of propylene in a first reaction zone in the presence of a first polymerization catalyst to provide a first quantity of polypropylene having a weight-average molecular weight M_{w,A}; (b) polymerizing a second quantity of propylene optionally mixed with a minor amount of one or more olefins other than propylene in a second reaction zone in the presence of a second polymerization catalyst to provide a second quantity of polypropylene comprising a polypropylene homopolymer or random copolymer and having a weight-average molecular weight M_{w,B}; and (c) combining the first quantity of polypropylene with the second quantity of polypropylene to form a bimodal polypropylene; wherein the percent by weight of the first quantity of polypropylene in the bimodal polypropylene composition is equal to or greater than 65 percent, and the ratio M_{w,B}/M_{w,A} is at least about 2.

### BACKGROUND OF THE INVENTION

1. Field of the Invention

The present invention relates to methods for producing high melt strength polypropylene.

2. Description of the Related Art

Polypropylene polymer resins have enjoyed significant growth in recent years. In addition to propylene homopolymer, numerous copolymers with ethylene and other alpha-olefins are now commercially produced. These include random copolymers, block copolymers and multi-phase polymer systems. This latter group of resins includes the so-called impact co-polymers and thermoplastic elastomers (TPEs), which contain a continuous phase of a crystalline polymer, e.g., highly isotactic polypropylene homopolymer, and those having a rubbery phase, e.g., ethylene-propylene copolymer.

These resins are widely used for extrusion for the production of films, fibers, and a wide variety of molded goods, such as bottles, hoses and tubing, automobile parts and the like. While it is necessary that these resins have sufficiently low melt viscosity under conditions of high shear encountered in the extruder, the resin must also have sufficient melt strength after extrusion to prevent sagging or distortion of the extrudate before it is cooled below the melt point. High melt strength resins are particularly advantageous for the production of large thermoformed and blow molded articles, as well as foam and sheet extrusions.

Several methods have been used for increasing the melt strength of polypropylene, including oxidation and radiative treatments. The introduction of long chain branching (“LCB”) has also been used (see, for example, Dang et al. U.S. Pat. No. 6,306,970 B1).

However, such methods typically require additional process steps beyond the steps required for the polymerization reaction. These additional steps pose several inconveniences including decreased processing efficiency and increased processing cost. Accordingly, it would be desirable to produce a high melt strength polypropylene by more convenient and less costly means.

### SUMMARY OF THE INVENTION

A method for making a polypropylene-containing composition is provided herein. The method comprises: (a) polymerizing a first quantity of propylene in a first reaction zone in the presence of a first polymerization catalyst to provide a first quantity of polypropylene having a weight-average molecular weight M_{w,A}; b) polymerizing a second quantity of propylene, optionally mixed with a minor amount of one or more olefins other than propylene, in a second reaction zone in the presence of a second polymerization catalyst to provide a second quantity of polypropylene comprising a polypropylene homopolymer or random copolymer and having a weight-average molecular weight M_{w,B}, and c) combining the first quantity of polypropylene with the second quantity of polypropylene to form a bimodal polypropylene composition; wherein the percent by weight of the first quantity of polypropylene in the bimodal polypropylene composition is equal to or greater than 65 percent, and the ratio M_{w,B}/M_{w,A} is at least about 2.

The method advantageously produces a high melt strength polypropylene, useful for various forming processes, including thermoforming and blow molding applications, without the need for additional processing steps beyond the polymerization process.

### BRIEF DESCRIPTION OF THE DRAWINGS

Various embodiments are described below with reference to the drawings wherein:

FIG. 1 is a graph illustrating the dependence of the ratio of M_{z}/M_{w} of a “zn-A & zn-B” bimodal resin with parameters of CR (the percentage of the first quantity of polypropylene A in the bimodal polypropylene composition) and M_{w,B}/M_{w,A};

FIG. 2 is a graph illustrating the dependence of the ratio of Mw/Mn of a “zn-A & zn-B” bimodal resin with parameters of CR and M_{w,B}/M_{w,A};

FIG. 3 is a graph illustrating the dependence of the ratio of M_{z}/M_{w} of a “ssc-A & ssc-B” bimodal resin with parameters of CR and M_{w,B}/M_{w,A};

FIG. 4 is a graph illustrating the dependence of the ratio of Mw/Mn of a “ssc-A & ssc-B” bimodal resin with parameters of CR and M_{w,B}/M_{w,A};

FIG. 5 is a graph illustrating the dependence of the ratio of Mz/Mw of a “zn-A & ssc-B” bimodal resin with parameters of CR and M_{w,B}/M_{w,A};

FIG. 6 is a graph illustrating the dependence of the ratio of Mw/Mn of a “zn-A & ssc-B” bimodal resin with parameters of CR and M_{w,B}/M_{w,A};

FIG. 7 is a graph illustrating the dependence of the ratio of Mz/Mw of a “ssc-A & zn-B” bimodal resin with parameters of CR and M_{w,B}/M_{w,A}; and,

FIG. 8 is a graph illustrating the dependence of the ratio of Mw/Mn of a “ssc-A & zn-B” bimodal resin with parameters of CR and M_{w,B}/M_{w,A}.

### DETAILED DESCRIPTION OF PREFERRED EMBODIMENTS

The melt strength of a polymer is dependent on the molecular distribution (MWD) of the polymer. The molecular weight distribution (MWD) of commercial polyolefins is typically broad. The breadth of this distribution, also known as polydispersity, is conventionally characterized by ratios of successive average molecular weights, such as M_{z}/M_{w} and M_{w}/Mₙ (see L. H. Peebles, Jr., “Molecular Weight Distributions in Polymers”, J. Wiley, New York (1971). While the M_{w}/Mₙ ratio is much more commonly used in the art as a measure of MWD polydispersity, it is the M_{z}/M_{w} ratio that is the controlling parameter for the melt strength of polyolefins (see U.S. Pat. No. 5,180,751 to Parks et al; R. N. Shroff and H. Mavridis, “New Measures of Polydispersity from Rheological Data on Polymer Melts”, J. Appl. Polym. Sci., 57, 1605-1626 (1995); and P. A. M. Steeman, “A Numerical Study of Various Rheological Polydispersity Measures”, Rheol. Acta, 37, 583-592 (1998)).

The two ratios, M_{z}/M_{w} and M_{w}/Mₙ, tend to trend together for unimodal MWDs, and thus, either ratio can be effective in characterizing MWD polydispersity. However, for bimodal MWDs, such as those resulting from polymerizations in two reactors in series, the situation is different; the two ratios, M_{z}/M_{w} and M_{w}/Mₙ, can move in opposing directions, over a certain range of the relevant parameters, as will be shown below. It has been found by the inventors that the more relevant to optimize is M_{z}/M_{w}.

The M_{z}/M_{w} and M_{w}/Mₙ ratios of a bimodal polyolefin are derived as follows. Let Mₙ, M_{w} and M_{z} be the number-, weight- and z-average molecular weights, respectively. They are calculated from the moments of the MWD, as follows:

$${M}_{n} = \frac{{m}_{0}}{{m}_{- 1}} , {M}_{w} = \frac{{m}_{1}}{{m}_{0}} , {M}_{z} = \frac{{m}_{2}}{{m}_{1}} \qquad ( 1 )$$

where mₖ is the k-order moment of the MWD, w(m):
mₖ=∫M^{k}·w(M)dM (2)
and w(M)·dM is the weight fraction between M and M+dM.

It can be shown that the moments of a blend of n-components, each with weight fraction φᵢ are:

$${m}_{k} = {\sum }_{i = 1}^{n} {φ}_{i} \cdot {m}_{i , k} \qquad ( 3 )$$

Using the standard normalizations of:

$$\begin{matrix}{m}_{0} = {m}_{i , 0} = 1 and {\sum }_{i = 1}^{n} {φ}_{i} = 1 \\ then \text{:} & ( 4 ) \\ {M}_{n} = \frac{{m}_{0}}{{m}_{- 1}} = \frac{1}{{\sum }_{i = 1}^{n} {φ}_{i} \cdot {m}_{- 1 , i}} = \frac{1}{{\sum }_{i = 1}^{n} {φ}_{i} \cdot \frac{1}{{M}_{n , i}}} & ( 5 ) \\ {M}_{w} = {\sum }_{i = 1}^{n} {φ}_{i} \cdot {M}_{w , i} & ( 6 ) \\ {M}_{z} = \frac{{m}_{2}}{{m}_{1}} = \frac{{\sum }_{i = 1}^{n} {φ}_{i} \cdot {m}_{i , 2}}{{M}_{w}} = \frac{{\sum }_{i = 1}^{n} {φ}_{i} \cdot {M}_{w , i} \cdot ( {M}_{z , i} / {M}_{w , i} )}{{M}_{w}} & ( 7 )\end{matrix}$$

and the M_{z}/M_{w} and M_{w}/Mₙ ratios can be calculated from equations 5-7 from the individual M_{w,i} and M_{z,i}/M_{w,i} values. If it is desired to consider Melt Index (MI) rather than molecular weight, then one can utilize the power-law dependence of MI on M_{w}, e.g., MI˜M_{w}^{-3.4}.

As a further aid for conceptualizing the above, consider the following hypothetical example. Consider a binary blend of components A (e.g., a first quantity of polypropylene) and B (e.g., a second quantity of polypropylene) with composition CR, where CR is the percentage of component A in the blend. Let M_{w} be the target weight-average molecular weight of the blend, M_{z} the z-average molecular weight of the blend, M_{w,A} the weight-average molecular weight of component A, and M_{w,B} the weight-average molecular weight of component B. The polydispersity (M_{z}/M_{w} and M_{w}/Mₙ) of the blend will vary with CR and the ratio of the two component molecular weights M_{w,B}/M_{w,A}. By using the equations below, one can determine M_{z}/M_{w} and M_{w}/Mₙ of the blend, on the basis of specified CR, M_{w}, M_{w,B}/M_{w,A} and (M_{z}/M_{w})_{A}, (M_{w}/Mₙ)_{A}, (M_{z}/M_{w})_{B}, (M_{w}/Mₙ)_{B}.

From eq. (6):

$${M}_{w} = \frac{CR}{100} \cdot {M}_{w , A} + \frac{100 - CR}{100} \cdot {M}_{w , B} ⇒ \frac{{M}_{w , A}}{{M}_{w}} = \frac{1}{\frac{CR}{100} + ( \frac{100 - CR}{100} ) \cdot ( \frac{{M}_{w , B}}{{M}_{w , A}} )} \qquad ( 8 )$$

From eq. (7):

$$\frac{{M}_{z}}{{M}_{n}} = ( \frac{CR}{100} ) \cdot {( \frac{{M}_{w , A}}{{M}_{w}} )}^{2} \cdot ( \frac{{M}_{z , A}}{{M}_{w , A}} ) + ( \frac{100 - CR}{100} ) \cdot {( \frac{{M}_{w , B}}{{M}_{w , A}} )}^{2} \cdot {( \frac{{M}_{w , A}}{{M}_{w}} )}^{2} \cdot ( \frac{{M}_{z , B}}{{M}_{w , B}} ) \qquad ( 9 )$$

wherein M_{z,A} is the z-average molecular weight of the first quantity of polypropylene and M_{z,B} is z-average molecular weight of the second quantity of polypropylene.

From eq. (5):

$$\frac{{M}_{w}}{{M}_{n}} = ( \frac{CR}{100} ) \cdot \frac{( \frac{{M}_{w , A}}{{M}_{n , A}} )}{( \frac{{M}_{w , A}}{{M}_{w}} )} + ( \frac{100 - CR}{100} ) \cdot \frac{( \frac{{M}_{w , B}}{{M}_{n , B}} )}{( \frac{{M}_{w , A}}{{M}_{w}} ) \cdot ( \frac{{M}_{w , B}}{{M}_{n , A}} )} \qquad ( 10 )$$

The invention requires a first quantity of propylene be polymerized in a first reaction zone in the presence of a first polymerization catalyst to provide a first quantity of polypropylene (i.e., component A). The invention also requires a second quantity of propylene be separately polymerized in a second reaction zone in the presence of a second polymerization catalyst to provide a second quantity of polypropylene (i.e., component B).

The second quantity of polypropylene has a weight-average molecular weight (M_{w,B}) which is at least about two times greater than the weight-average molecular weight of the second quantity of polypropylene (M_{w,B}), i.e., M_{w,B}≧2×M_{w,A}, and thus, the ratio M_{w,B}/M_{w,A} is at least about 2. More preferably, the ratio of M_{w,B}/M_{w,A} is at least about 5, more preferably at least about 7, more preferably at least about 10, and even more preferably at least about 20.

The value of M_{w,A} is preferably equal to or less than 1,000,000. Some particularly suitable values of M_{w,A} include 900,000, 800,000, 700,000, 600,000, 500,000, 400,000, 300,000, 200,000, 100,000, 80,000, 60,000, 50,000, 30,000, 20,000, 10,000, and 5,000.

The value of M_{w,B} is preferably equal to or greater than 10,000. Some particularly suitable values of M_{w,B} include 20,000, 50,000, 100,000, 200,000, 500,000, 800,000, 1,000,000, 2,000,000, 5,000,000, and higher values.

The first quantity of propylene is preferably not combined with other olefins. More preferably, the first quantity of propylene is of at least acceptable purity for the production of polypropylene homopolymer. Even more preferably, the first quantity of propylene is of a purity level having, at most, residual levels of other olefin impurities.

The second quantity of propylene can be in the absence of other olefins, or alternatively, can be combined with one or more other olefins (i.e., comonomers) for the production of a polypropylene random copolymer composition. Preferably, the comonomer olefins have two to ten carbon atoms. More preferably, the comonomer olefins contain two, four, five, or six carbon atoms (i.e., C₂ or C₄-C₆ olefins).

Some examples of suitable comonomer olefins include ethylene, 1-butene, 2-butene, 2-methyl-1-butene, 3-methyl-1-butene, 2-methyl-2-butene, 2,3-dimethyl-2-butene, 1pentene, 2-pentene, 2-methyl-1-pentene, and 1-hexene.

In a preferred embodiment, the second quantity of propylene includes one or more comonomer olefins. Preferably, the comonomer olefins are present in a minor amount. A “minor amount” of comonomer is preferably an amount of, or less than, thirty percent by weight of the total olefin composition. More preferably, the comonomer is in an amount of, or less than, twenty percent by weight, and even more preferably, ten percent by weight, of the total olefin composition.

Accordingly, it is preferable for the propylene component in the presence of comonomers to be present in at least seventy percent by weight, more preferably at least eighty percent by weight, and even more preferably ninety percent by weight of the total olefin composition. For example, some particularly preferred compositions for the second quantity of propylene include 70:30, 75:25, 80:20, 85:15, 90:10, and 95:5 propylene:comonomer percent weight ratios.

The first quantity of polypropylene is preferably a homopolymer composition. The polypropylene can be of any suitable tacticity, including random, isotactic, and syndiotactic forms of polypropylene. Mixtures of different forms of polypropylene are also contemplated.

The second quantity of polypropylene can be a homopolymer composition, as described above. Alternatively, the second quantity of polypropylene can be a random copolymer derived from propylene in combination with one or more other types of monomers.

The polymerization catalysts used in the method can be any suitable catalyst capable of polymerizing propylene. More preferably, the polymerization catalyst is a Ziegler-Natta catalyst (i.e., “zn”) or single site catalyst (i.e., “ssc”).

A Ziegler-Natta catalyst can be any suitable Ziegler-Natta catalyst or a modified form thereof, but preferably comprises a titanium or vanadium compound combined with an aluminum co-catalyst. A particularly preferred Ziegler-Natta catalyst results from a combination of titanium tetrachloride and triethylaluminum. The Ziegler-Natta catalyst may also include, inter alia, internal and external electron donor compounds.

A preferred class of single site catalysts include any of the catalytically active metallocenes known in the art. Some examples of such single site catalysts include bis(n-butyl cyclopentadienyl)zirconium dichloride, the siloxy-substituted bridged bis-indenyl zirconium dihalides, trans-1,2-cyclohexylenebis(1-indenyl)zirconium dichloride, and the bis(n-butyl cyclopentadienyl)hafnium dihalides. The single site catalysts are typically used in combination with an aluminoxane co-catalyst, e.g., methylaluminoxane (MAO), tetraisobutylaluminoxane (TIBAO), or hexaisobutylaluminoxane (HIBAO).

The polymerization catalysts may be supported or unsupported. Some examples of suitable supports include silica, silica-alumina, alumina, magnesium oxide, titania, zironia, and magnesium silicate.

The first and second polymerization catalysts can be the same or different. For example, in one embodiment, both the first and second polymerization catalysts are Ziegler-Natta catalysts of the same or different compositions. In another embodiment, the first and second polymerization catalysts are both single site catalysts of the same or different compositions. In another embodiment, the first polymerization catalyst is a Ziegler-Natta catalyst and the second polymerization catalyst is a single site catalyst. In yet another embodiment, the first polymerization catalyst is a single site catalyst and the second polymerization catalyst is a Ziegler-Natta catalyst.

The weight-average molecular weights of each of the first and second quantities of polypropylene are regulated according to any suitable methods known in the art. For example, in a preferred embodiment, the molecular weight of each quantity of polypropylene is regulated by altering the hydrogen gas concentration during polymerization. Alternatively, polymerization halting compounds, as known in the art, can be added at varying times during the polymerization reaction. The polymerization catalyst, reaction time, pressure, and temperature, can also be modulated to regulate the molecular weights of the first and second quantities of polypropylene.

According to the method of the invention, the first quantity of polypropylene (A) and the second quantity of polypropylene (B), with the properties described above, are combined to form a bimodal polypropylene composition having a higher M_{z}/M_{w} ratio than the M_{z}/M_{w} ratios of each of the first and second quantities of polypropylene. In other words, M_{z}/M_{w} (the melt strength indicator for the bimodal polypropylene) is higher than (M_{z}/M_{w})ₐ (the melt strength indicator for the first quantity of polypropylene, component A) and higher than (M_{z}/M_{w})_{b} (the melt strength indicator for the second quantity of polypropylene, component B).

Preferably, to achieve this higher melt strength, the percent by weight of the first quantity of polypropylene (A) based upon total composition weight is equal to or greater than sixty-five percent (65%). More preferably, the percent by weight of the first quantity of polypropylene is equal to or greater than eighty percent, more preferably eighty-five percent, and even more preferably ninety percent. Higher percentages by weight of A, e.g., 95%, 97%, or 98%, may also be preferred in some embodiments.

In a preferred embodiment, the bimodal polypropylene composition has a M_{z}/M_{w} ratio of at least about 5.0. More preferably, the M_{z}/M_{w} ratio is at least about 6.0, more preferably 7.0, more preferably 8.0, more preferably 9.0, and even more preferably 10.

At least two reaction zones (i.e., the first and second reaction zones) are employed in the method of the invention. The reaction zones can be interconnected by any suitable arrangement that would allow the first and second quantities of polypropylene to be combined to form the bimodal polypropylene composition.

For example, the first and second quantities of polypropylene can be combined by arranging the first and second reaction zones in series. An example of a suitable series arrangement includes a process step wherein at least some portion of the first quantity of polypropylene produced in the first reaction zone is transferred into the second reaction zone holding the second quantity of polypropylene. Another example of a suitable series arrangement includes a process step wherein at least some portion of the second quantity of polypropylene produced in the second reaction zone is transferred into the first reaction zone holding the first quantity of polypropylene.

Alternatively, the first and second quantities of polypropylene can be combined by arranging the first and second reaction zones in parallel. An example of a suitable parallel arrangement includes a process step wherein at least some portion of each of the first and second quantities of polypropylene are transferred to a separate reactor or mixing zone.

Once combined, the polypropylene fractions are preferably mixed, blended, or further processed by any suitable means known in the art.

Each of the first and second reaction zones can include one or more reactors and other auxilliary equipment (e.g., mixers, transfer devices, interconnectors, temperature and pressure sensors and regulators, and the like). The reactors can be any of the suitable reactors known in the art for polymerization reactions. For example, the reactors can be selected from the group of slurry and gas phase reactors. A particularly preferred slurry reactor is a loop reactor.

The polymerization reactions can be conducted under any of the suitable conditions known in the art. For example, one or both of the polymerization reactions can be conducted in either the gas phase or in a liquid phase. In a liquid phase, the polymerization reactions are typically conducted in a slurry phase.

The as-produced bimodal polypropylene composition can be further processed to modify or adjust its physical properties. For example, the bimodal polymer can be molded, extruded, melted, cooled, compressed, heat treated, irradiated, oxidized, or chemically reacted, as desired, according to any suitable range of applications. The bimodal polymer can also be dissolved in a solvent, if applicable, for application as a film or coating.

A description of the figures is given below. In the figures, the component “A” represents the first quantity of polypropylene and the component “B” represents the second quantity of polypropylene. As described above, component A is of a lower molecular weight than component B. The composition ration (CR) represents the percent composition by weight of A in the bimodal polypropylene composition. For illustration, we will assume for a Ziegler-Natta (“zn”) component (M_{z}/M_{w})zn=(M_{w}/Mₙ)zn=4 and for a Single-Site (“ssc) component (M_{z}/M_{w})ssc=1.5 and M_{w}/Mₙ)ssc=2.

FIGS. (1) and (2) show the variation of M_{z}/M_{w} and M_{w}/Mₙ, respectively, as a function of the weight percentage of A (i.e., CR) in the bimodal polypropylene composition where both A and B component are made via Ziegler-Natta catalysts. The following observations can be made:
The curve for M_{z}/M_{w} is qualitatively and quantitatively different from that for M_{w}/Mₙ
The M_{w}/Mₙ ratio is maximum at about CR=50%. However, the optimum composition for maximizing M_{z}/M_{w} (and thus maximizing melt strength) is CR>65%—typically at CR˜80-90% for M_{w,A}/M_{w,B}>2.

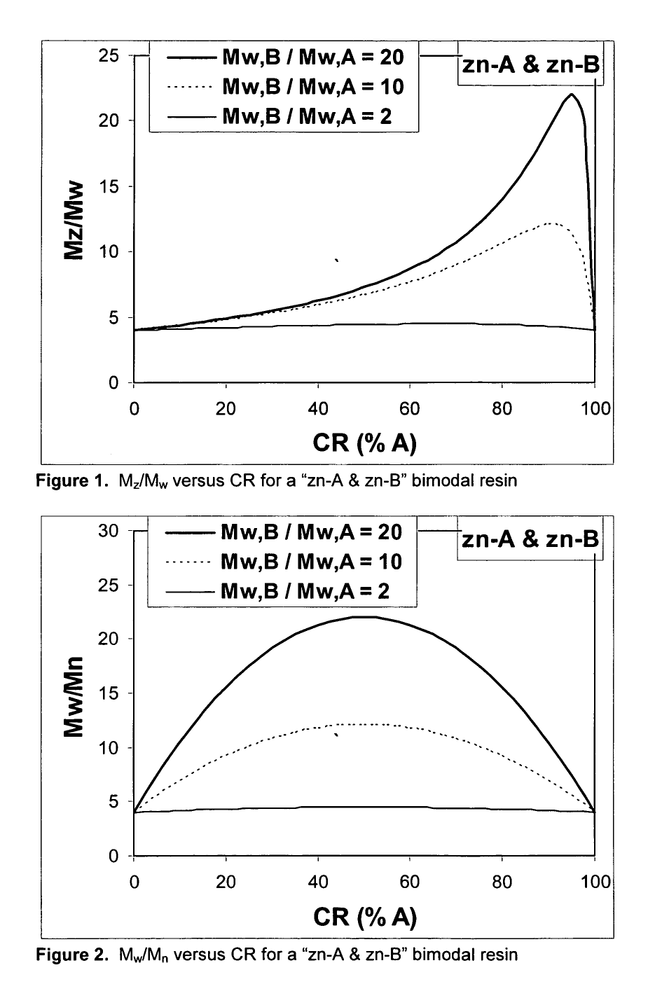

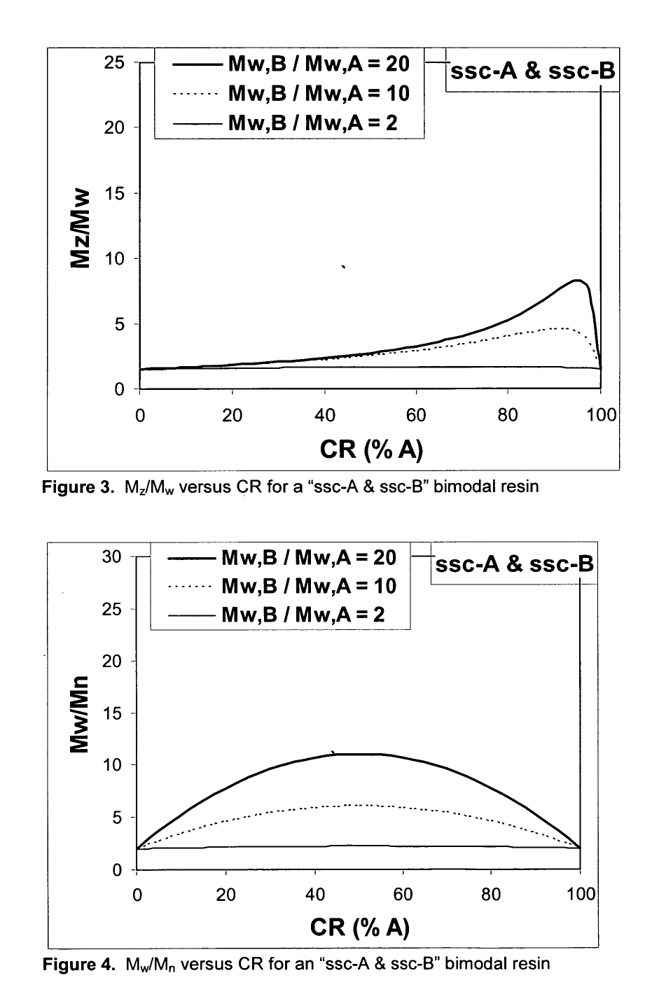

FIGS. (3) and (4) show the variation of M_{z}/M_{w} and M_{w}/Mₙ, respectively, as a function of CR for a bimodal resin where both A and B components are made via single site catalysts (ssc). Both M_{z}/M_{w} and M_{w}/Mₙ in FIGS. 3 and 4 are lower than in FIGS. 1 and 2.

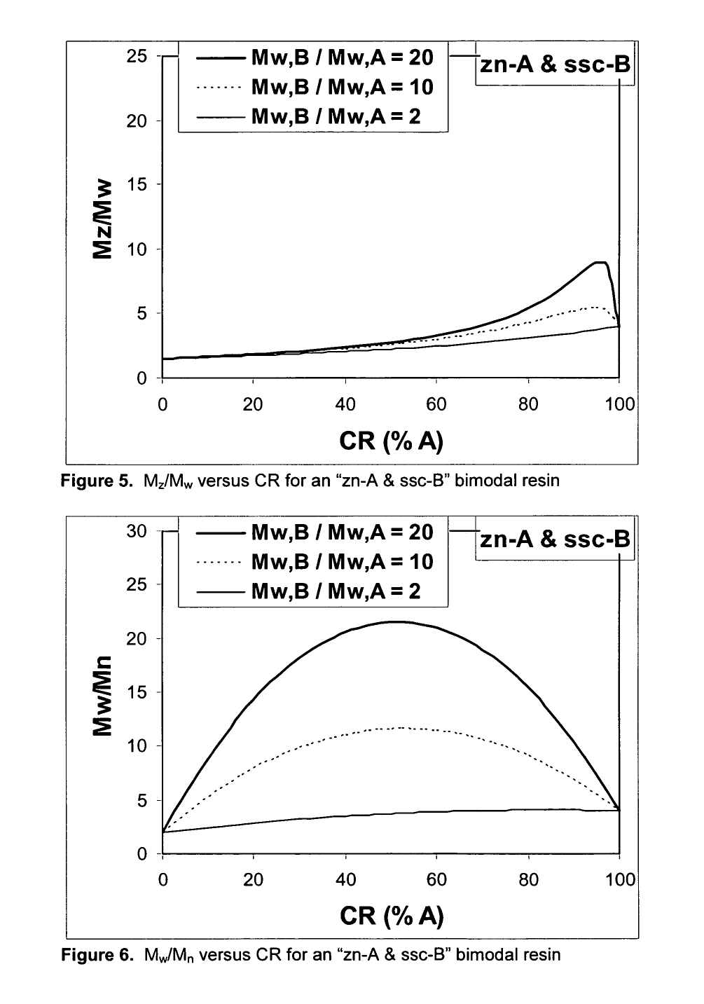

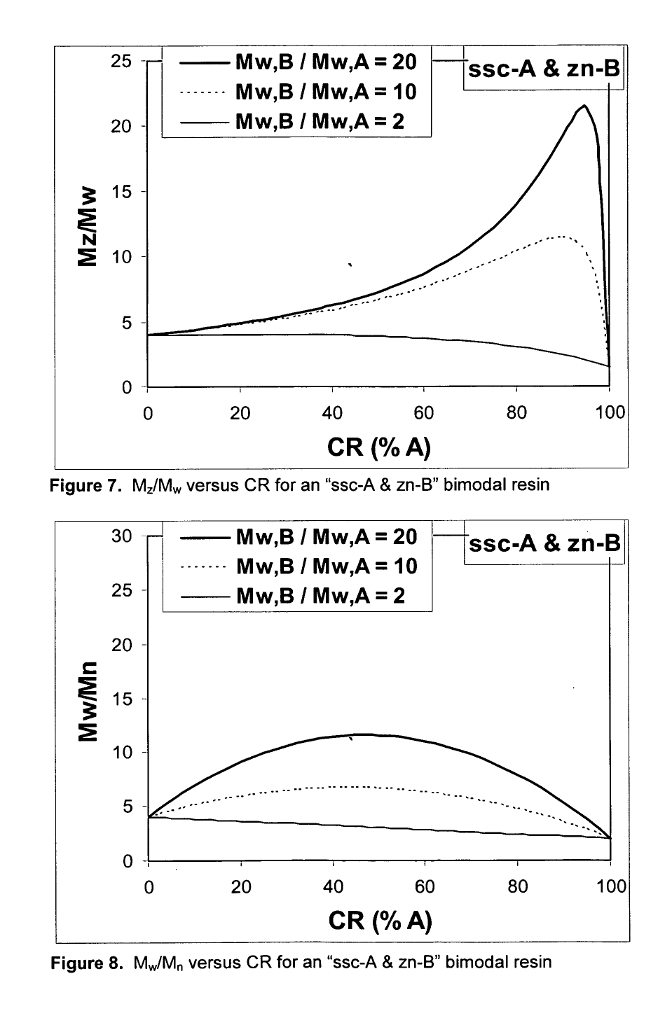

FIGS. 5 and 6 show the variation of M_{z}/M_{w} and M_{w}/Mₙ, respectively, as a function of CR for a bimodal resin where a Ziegler-Natta catalyst was used for producing the A component and a single site catalyst was used for producing the B component. FIGS. 7 and 8 show the variation of M_{z}/M_{w} and M_{w}/Mₙ, respectively, as a function of CR for a bimodal resin where a single site catalyst was used for producing the A component and a Ziegler-Natta catalyst was used for producing the B component.

It can be readily observed from FIGS. 1-8 that the choice of catalyst for the B-component (zn or ssc) dominates the behavior of M_{z}/M_{w}, whereas the choice of catalyst for the A-component (zn or ssc) dominates the behavior of M_{w}/Mₙ.

Thus, whereas there have been described what are presently believed to be the preferred embodiments of the present invention, those skilled in the art will realize that other and further embodiments can be made without departing from the spirit of the invention, and it is intended to include all such further modifications and changes as come within the scope of the claims set forth herein.

We claim:

1. A method for making a polypropylene-containing composition comprising:
a) polymerizing a first quantity of propylene in a first reaction zone in the presence of a first polymerization catalyst to provide a first quantity of polypropylene having a weight-average molecular weight M_{w,A};
b) polymerizing a second quantity of propylene, optionally mixed with a minor amount of one or more olefins other than propylene, in a second reaction zone in the presence of a second polymerization catalyst to provide a second quantity of polypropylene comprising a polypropylene homopolymer or random copolymer and having a weight-average molecular weight M_{w,B}, and
c) combining the first quantity of polypropylene with the second quantity of polypropylene to form a bimodal polypropylene composition;
wherein the percent by weight of the first quantity of polypropylene in the bimodal polypropylene composition is equal to or greater than 65 percent, and the ratio M_{w,B}/M_{w,A} is at least about 2.

2. The method according to claim 1, wherein said olefins other than propylene are olefins having two, four, five or six carbon atoms.

3. The method of claim 1 wherein the value of M_{w,A} is less than or equal to 1,000,000.

4. The method of claim 1 wherein the value of M_{w,B} is greater than 10,000.

5. The method of claim 1 wherein M_{w,B}/M_{w,A} is at least about 5.

6. The method of claim 1 wherein M_{w,B}/M_{w,A} is at least about 7.

7. The method of claim 1 wherein the percent by weight of the first quantity of polypropylene in the bimodal polypropylene composition is equal to or greater than about eighty percent.

8. The method of claim 1 wherein the percent by weight of the first quantity of polypropylene in the bimodal polypropylene composition is equal to or greater than about ninety percent.

9. The method of claim 1 wherein the first quantity and second quantity of propylene are combined according to step (c) in series such that at least some of the first quantity of polypropylene of step (a) is transferred into the second reaction zone holding the second quantity of polypropylene of step (b).

10. The method of claim 1 wherein the first quantity and second quantity of propylene are combined according to step (c) in series wherein at least some of the second quantity of polypropylene of step (b) is transferred into the first reaction zone holding the first quantity of polypropylene of step (a).

11. The method of claim 1 wherein the first quantity and second quantity of propylene are combined according to step (c) in parallel wherein at least some portion of each of the first and second quantities of polypropylene are transferred into a separate reactor or mixing zone.

12. The method of claim 1 wherein the second quantity of propylene includes a minor amount of ethylene so as to provide a mixture containing at least 70 percent by weight of propylene and no more than 30 percent by weight of ethylene.

13. The method of claim 1 wherein the second quantity of propylene includes a minor amount of ethylene so as to provide a mixture containing at least 80 percent by weight of propylene and no more than 20 percent by weight of ethylene.

14. The method of claim 1 wherein the second quantity of propylene includes a minor amount of ethylene so as to provide a mixture containing at least 90 percent by weight of propylene and no more than 10 percent by weight of ethylene.

15. The method of claim 1 wherein at least one of said first and second polymerization catalysts is a Ziegler-Natta catalyst.

16. The method of claim 1 wherein at least one of said first and second polymerization catalysts is a single site catalyst.

17. The method of claim 14, wherein the single site catalyst is a metallocene catalyst.

18. The method of claim 1 wherein the bimodal polypropylene composition is a polypropylene homopolymer.

19. A method for making a polypropylene-containing composition comprising:
a) polymerizing a first quantity of propylene in a first reaction zone in the presence of a first polymerization catalyst to provide a first quantity of polypropylene having a weight-average molecular weight M_{w,A};
b) polymerizing a second quantity of propylene, optionally mixed with a minor amount of one or more olefins other than propylene, in a second reaction zone in the presence of a second polymerization catalyst to provide a second quantity of polypropylene comprising a polypropylene homopolymer or random copolymer and having a weight-average molecular weight M_{w,B}, and
c) combining the first quantity of polypropylene with the second quantity of polypropylene to form a bimodal polypropylene composition;
wherein the percent by weight of the first quantity of polypropylene in the bimodal polypropylene composition is equal to or greater than 65 percent, and the ratio M_{w,B}/M_{w,A} is at least about 2, and wherein the bimodal polypropylene composition formed in step (c) has a M_{z}/M_{w} ratio of at least about 5, and is calculated according to the formula
$$\frac{{M}_{z}}{{M}_{w}} = ( \frac{CR}{100} ) \cdot {( \frac{{M}_{w , A}}{{M}_{w}} )}^{2} \cdot ( \frac{{M}_{z , A}}{{M}_{w , A}} ) + ( \frac{100 - CR}{100} ) \cdot {( \frac{{M}_{w , B}}{{M}_{w , A}} )}^{2} \cdot {( \frac{{M}_{w , A}}{{M}_{w}} )}^{2} \cdot ( \frac{{M}_{z , B}}{{M}_{w , B}} )$$
wherein M_{w} is a weight-average molecular weight of the bimodal polypropylene composition, M_{z} is a z-average molecular weight of the bimodal polypropylene composition, M_{z,A} is a z-average molecular weight of the first quantity of polypropylene M_{z,B} is a z-average molecular weight of the second quantity of polypropylene, M_{w,A} is a weight-average molecular weight of the first quantity of polypropylene, and M_{w,B} is a weight-average molecular weight of the second quantity of polypropylene.

20. The method of claim 20 wherein the M_{z}/M_{w} ratio is at least about 7.0.
